(19) United States
(12) Patent Application Publication
(10) Pub. No.: US 2025/0307101 A1
(43) Pub. Date: Oct. 2, 2025

(54) OBSERVABILITY-BASED CONFIGURATION REMEDIATION FOR COMPUTING ENVIRONMENTS

(71) Applicant: International Business Machines Corporation, Armonk, NY (US)

(72) Inventors: Rachel Tzoref-Brill, Haifa (IL); Sharon Keidar Barner, Megiddo (IL); Eran Raichstein, Yokneam Ilit (IL); Ofer Biran, Haifa (IL)

(21) Appl. No.: 18/616,578

(22) Filed: Mar. 26, 2024

(51) Int. Cl. G06F 11/30; G06F 40/35

(52) U.S. Cl. CPC G06F 11/3065; G06F 11/2252; G06F 40/35

(57) ABSTRACT

Observability-based configuration remediation for use in a computing environment is disclosed. For example, a method includes detecting an incident in a computing environment and obtaining information related to the incident, the information including a dynamic state information set and a static state information set. The method further includes summarizing the information related to the incident as a textual prompt and then inputting the textual prompt into one or more machine learning models such that the one or more machine learning models, in response, generates an output including a resolution to the incident.

### BACKGROUND

The present application relates to computing environments such as distributed computing environments, to artificial intelligence, and to techniques for using artificial intelligence for configuration remediation in such computing environments.

### SUMMARY

Embodiments provide observability-based configuration remediation for computing environments.

In one illustrative embodiment, a computer-implemented method includes detecting an incident in a computing environment. The computer-implemented method further includes obtaining information related to the incident, the information including a dynamic state information set and a static state information set. The computer-implemented method further includes summarizing the information related to the incident as a textual prompt. The computer-implemented method further includes inputting the textual prompt into one or more machine learning models such that the one or more machine learning models, in response, generates an output comprising a resolution to the incident. The computer-implemented method is performed by a processing platform when executing program code, the processing platform including one or more processing devices, each of the one or more processing devices including a processor coupled to a memory.

In another illustrative embodiment, a computer system comprising a processor set, a set of one or more computer-readable storage media, and program instructions, collectively stored in the set of one or more storage media, for causing the processor set to perform computer operations including detecting an incident in a computing environment. The computer operations further include obtaining information related to the incident, the information including a dynamic state information set and a static state information set. The computer operations further include summarizing the information related to the incident as a textual prompt. The computer operations further include inputting the textual prompt into one or more machine learning models such that the one or more machine learning models, in response, generates an output comprising a resolution to the incident.

In yet another illustrative embodiment, a computer program product includes a computer readable storage medium having program instructions embodied therewith which, when executed, cause the one or more processors to perform computer operations including detecting an incident in a computing environment. The computer operations further include obtaining information related to the incident, the information including a dynamic state information set and a static state information set. The computer operations further include summarizing the information related to the incident as a textual prompt. The computer operations further include inputting the textual prompt into one or more machine learning models such that the one or more machine learning models, in response, generates an output comprising a resolution to the incident.

These and other objects, features and advantages of the present disclosure will become apparent from the following detailed description of illustrative embodiments thereof, which is to be read in connection with the accompanying drawings.

### BRIEF DESCRIPTION OF THE DRAWINGS

FIG. 1 illustrates a distributed computing environment in which one or more illustrative embodiments may be implemented.

FIG. 2 illustrates an operational flow for an observability-based configuration remediation system according to an illustrative embodiment.

FIG. 3 illustrates a methodology for an observability-based configuration remediation system according to an illustrative embodiment.

FIG. 4 illustrates an example application of the operational flow of FIG. 2 and/or the methodology of FIG. 3 applied to a computing environment according to an illustrative embodiment.

FIG. 5 illustrates another example of a computing environment in which one or more illustrative embodiments may be implemented.

FIG. 6 illustrates an operational flow for a prompt engineering system within an observability-based configuration remediation system according to an illustrative embodiment.

FIG. 7 illustrates an example of pseudocode for implementing the operational flow of FIG. 6 according to an illustrative embodiment.

FIG. 8 illustrates a methodology for observability-based configuration remediation according to an illustrative embodiment.

FIG. 9 illustrates a methodology for improving a large language model based on remediated configurations according to an illustrative embodiment.

FIG. 10 illustrates yet another example of a computing environment in which one or more illustrative embodiments may be implemented.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass a wide variety of processing systems, by way of example only, processing systems including microservices, cloud, core and edge computing and storage systems as well as other types of processing systems including various combinations of physical and/or virtual processing resources. A cloud computing environment may be considered an example of an information processing system.

Complex computing environments are becoming an important resource implemented by many entities including, but not limited to, enterprises and other entities with many users of computing devices that are geographically or otherwise dispersed. For example, such computing environments can extend beyond centralized clouds to implement distributed, multi-cloud and edge deployments. Accordingly, the efficient and effective resolution of functional failures and performance failures is increasingly important. In a computing environment, a functional failure occurs when a component or system within the computing environment does not perform its intended function. A performance failure occurs when a component or system within the computing environment does not meet user expectations for speed, reliability, and/or functionality. Part of resolving functional failures and performance failures is troubleshooting (also referred to herein as “debugging”). Troubleshooting is a part of computing environment management that involves tracing and correcting issues and failures within a computing environment. However, troubleshooting functional failure and performance failure incidents is time consuming and costly. Complex computing environments, such as cloud computing environments and other distributed computing environments, expose developers and site reliability engineers (SREs) to enormous configuration spaces, which makes debugging difficult.

As illustratively used herein, the term configuration refers to a selective arrangement of resources of a system (e.g., a computing environment). The selection may typically depend on the nature, number and/or characteristics (e.g., parameters, attributes, controls, functions, etc.) of a given resource. Often, configuration pertains to the choice of hardware (e.g., processing, storage, and/or network devices), software (e.g., applications, microservices, etc.), firmware, and/or documentation associated with a system, as well as any and all selectable parameters thereof.

Misconfigurations of such complex computing environments pose a high level of risk for security, performance and functionality issues and failures. A large number of issues and failures within complex computing environments can be traced back to preventable misconfigurations and/or mistakes made by end users, which are usually resolved with configuration changes.

There are a number of technologies developed for root cause failure analysis for operational incidents in computing environments such as microservice computing environments and/or cloud computing environments. However, the previously-developed technologies typically only consider the dynamic state of the computing environment when performing root cause failure analysis and remediation recommendation processes. The dynamic state of a computing environment, as used herein, illustratively refers to portions of the computing environment that are frequently changed. The dynamic state of a computing environment should be continuously observed and monitored and/or subject to recurrent status information collection at regular intervals to track the changes (e.g., dynamic state information may include data that is collected as part of system logs, traces, metrics and/or events). It is realized herein that only considering the dynamic state of a computing environment often results in ineffective issue resolution and difficulty locating failures, especially when the failure is related to a static state of the computing environment. The static state of a computing environment, as used herein, illustratively refers to portions of the computing environment that are not changed or that are infrequently changed. The static state of a computing environment is typically fixed and does not change unless a change is intentionally enacted, e.g., static state information may be related to the type and number of entities within the computing environment and infrastructure resource configurations. Additionally, conventional root cause failure analysis and remediation recommendation processes merely output results of a root cause failure analysis and a general remediation recommendation to a user (e.g., a developer, SRE, administrator, platform engineer or operator of the computing environment), which then further costs time and resources to enact a remediation. Furthermore, without the configuration information, a root cause failure analysis may not be capable of detecting that the problem is in the configuration, so the failure may be unsolvable without considering the configuration of the computing environment.

Illustrative embodiments of the present disclosure overcome issues with conventional root cause failure analysis and remediation recommendation processes by adding static state information of an incident (e.g., issue and/or failure) within a computing environment to a prompt or problem definition. This is advantageous since the static state information contains valuable information that can reveal the direction for resolution of the incident. Illustrative embodiments further overcome the technical drawbacks of conventional root cause failure analysis and remediation recommendation processes by improving automatic configuration generation using machine learning models such as, for example, configuration generation coding (CGC) large language models (LLMs) (referred to herein collectively as “CGC LLMs” or individually as “CGC LLM”). For example, illustrative embodiments may use the remediation recommendation output to further serve as an input for one or more CGC LLMs to improve (e.g., train and retrain) the automatic configuration generation performance of the CGC LLM with reinforcement learning. Accordingly, observability-based configuration remediation according to illustrative embodiments incorporates both the dynamic state information and static state information of the computing environment incident to reveal a direction for resolution of the incident efficiently and effectively, e.g., by reducing time expenditures and resource costs.

As an example, assume a computing environment operates with a Kubernetes® container orchestration platform. In a platform such as Kubernetes®, containers are instantiated and processes are executed via the containers on nodes. Thus, in some embodiments, a set of one or more nodes that execute one or more processes via one or more containers is considered a cluster, and a distributed computing environment can include one or more clusters. Assume further that an event signal indicates that an “erroneous call rate is too high” between two computing devices or modules in the distributed computing environment, e.g., calls from a Prometheus® adapter to an application programming interface (API) service. Prometheus® is an open-source monitoring and alerting toolkit designed for microservices and containers that enables flexible queries and configuration of real-time notifications. The Prometheus® adapter helps query and leverage custom metrics collected by the Prometheus® toolkit, and then utilizes the metrics to make scaling decisions. These metrics are exposed by an API service and can be used for pod autoscaling in the Kubernetes® environment. Thus, in this example, assume that the environmental context is that a Kubernetes® upgrade is ongoing and that the relevant configuration file is the Prometheus® adapter. It is further assumed that a relevant suspicious configuration parameter being considered is a timeout raised due to the allegedly high erroneous call rate. However, the dynamic state information (e.g., from logs, traces, metrics, etc.) for this event signal does not contain the configuration options. Simply entering the dynamic state information into a CGC LLM would result in the model asking more questions or giving a vague answer.

As another example, assume an event signal indicates that “maximum CPU utilization on node” has occurred wherein the node resides in the computing environment under consideration. The node is a Kubernetes® node in some circumstances. The environmental context of this computing environment is that a toleration definition exists in the pod configuration. A toleration definition allows a Kubernetes® pod to be scheduled on a node with a matching taint. A taint is a Kubernetes® node property that enables nodes to repel certain pods. In this example, the relevant suspicious configuration file would be the pod specification. The relevant configuration parameter would be the taint's key/value in the pod toleration definition, which is likely not compatible with the node associated with the event signal. However, the relevant dynamic state information for this event signal does not contain the pod configuration. Simply entering the dynamic state information into a CGC LLM would again result in the model asking significantly more questions or giving an indefinite answer.

As yet another example, assume an event signal indicates that there is “insufficient memory” in the computing environment. The environmental context of this computing environment is that there is no toleration definition. The relevant suspicious configuration file would be the deployment specification. The relevant configuration parameter would be the memory limits and the memory request. However, the relevant dynamic state information for this event signal does not contain the deployment specification. Again, simply entering the dynamic state information into a CGC LLM would result in the model asking significantly more questions or giving an indefinite answer.

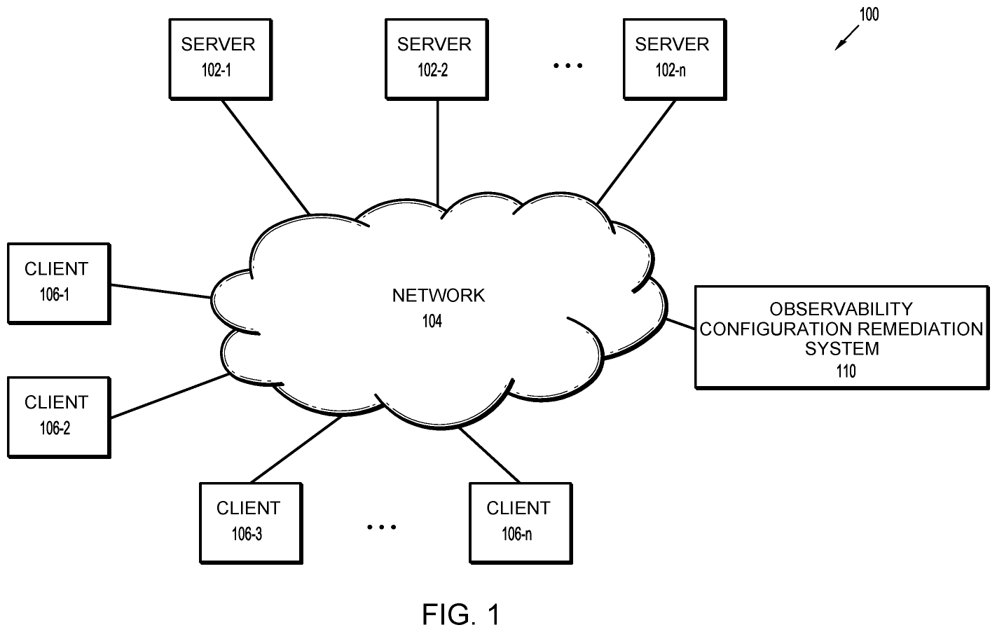

Referring initially to FIG. 1, a computing environment 100 is depicted in which one or more illustrative embodiments can be implemented. For example, computing environment 100 includes a network 104, servers 102-1, 102-2 . . . 102-n (collectively referred to as servers 102) and clients 106-1, 106-2, 106-3 . . . 106-n (collectively referred to as clients 106) with an observability-based configuration remediation system 110 used to collect and analyze observability information from the whole of computing environment 100. In some embodiments, the network 104 may be a communication network (e.g., a public network such as the internet, a private network associated with an enterprise, or some combination thereof). In some embodiments, the clients 106, the servers 102, and the observability-based configuration remediation system 110 are coupled via the network 104.

In some embodiments, computing environment 100 is a cloud computing environment that is service oriented with a focus on statelessness, low coupling, modularity, and semantic interoperability. In some embodiments, servers 102 may include underlying cloud infrastructure including operating systems, storage, or even individual application capabilities. In some embodiments, clients 106 may be administrators, SREs, platform engineers, developers, platform operators, etc. The observability-based configuration remediation system 110 collects data to provide the ability to analyze a computing environment's current state. Because cloud services rely on a uniquely distributed and dynamic architecture, observability-based configuration remediation system 110 may also include specific software tools and practices enterprises use to interpret cloud performance data.

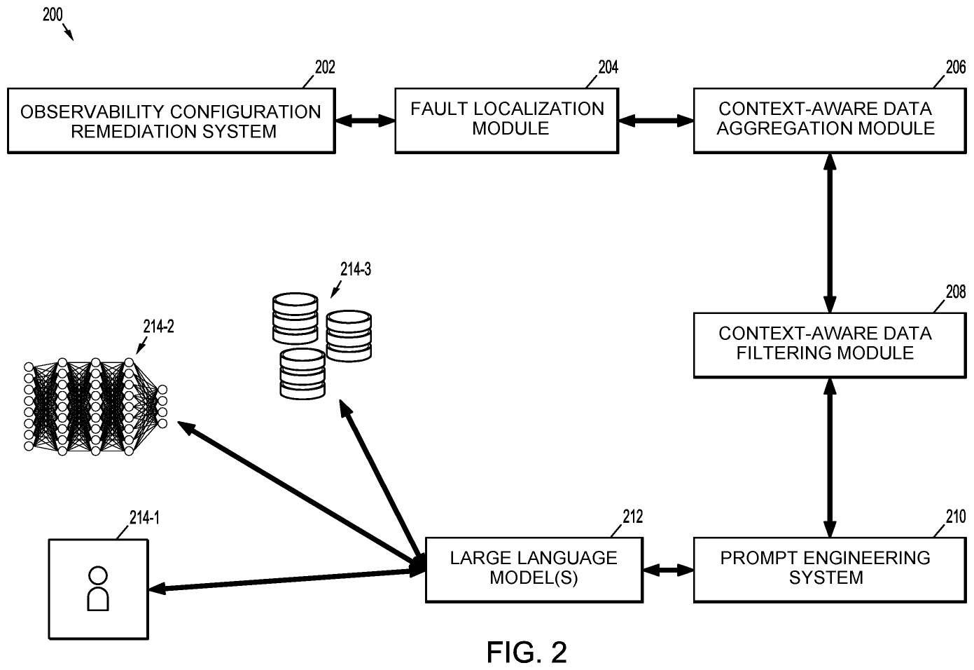

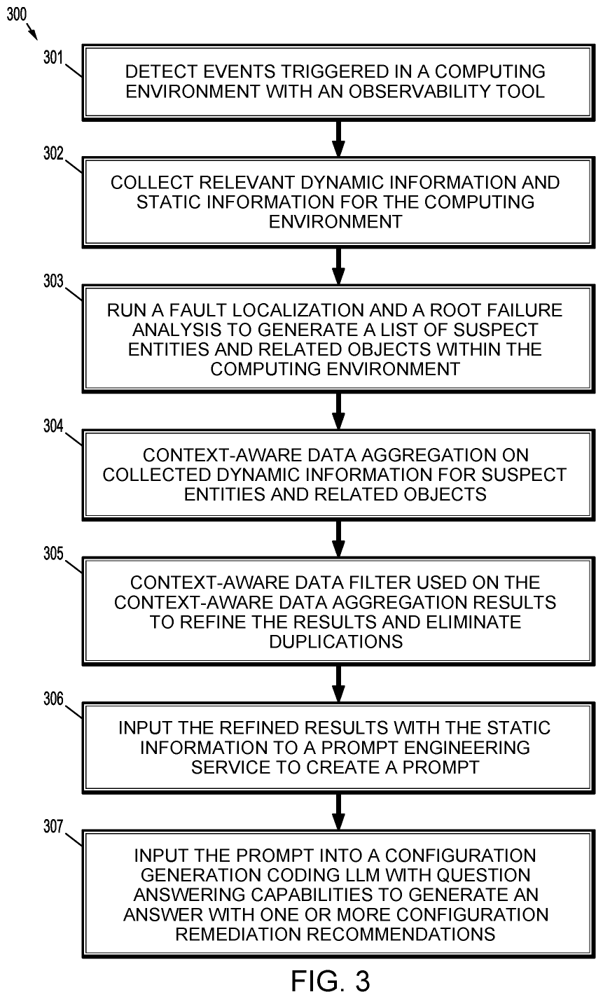

Turning now to FIGS. 2 and 3, an operational flow 200 and a methodology 300 are depicted to show processes executed by the observability-based configuration remediation system 110 in an illustrative embodiment as shown. In some embodiments, the methodology 300 can be considered one example of the operational flow 200 of FIG. 2. In some embodiments, the operational flow 200 and the methodology 300 are executed by the observability-based configuration remediation system 110 in accordance with data collected from servers 102 and/or clients 106.

At step 301, an observability tool 202 (e.g., a component of observability-based configuration remediation system 110) is triggered by an incident in a computing environment (e.g., computing environment 100) to detect events in the computing environment. In some embodiments, the incident may be a functional failure and/or a performance failure of the computing environment 100.

At step 302, the observability tool 202 collects a computing environment's state information. The state information collected includes relevant dynamic state information such as events, traces, logs, and metrics of a given time window spanning before and after the detection of the incident. The state information collected further includes static state information such as a state of one or more applications in the computing environment, a state of one or more infrastructure components of the computing environment, a configuration of the computing environment, and one or more resource types of the computing environment.

At step 303, a fault localization process is run on the collected dynamic state information and static state information using, for example, fault localization module 204 (e.g., a component of observability-based configuration remediation system 110). In some embodiments, the fault localization process may be performed with, for example, a VELOS™ platform to identify suspect entities. The fault localization process generates a list of suspect entities and related objects within the computing environment. In some embodiments, a root cause failure analysis may also be applied to the collected dynamic state information and static state information. In some embodiments, the root cause failure analysis may be optional. In some embodiments, the root cause failure analysis may be an automatic process. In some embodiments, the root cause failure analysis may be a manual or semi-automatic process executed by developers, administrators, SREs, platform engineers, platform operators and/or users. The fault localization process and the optional root cause failure analysis may pinpoint the entities and objects which may be causing the issue or failure within the computing environment and triggering the incident alert in the observability tool 202.

At step 304, a context-aware data aggregation process is executed on the collected dynamic state information for the suspect entities and the related objects to organize and process the dynamic state information. The context-aware data aggregation process is executed with, for example, a context-aware data aggregation module 206 (e.g., a component of observability-based configuration remediation system 110). In some embodiments, the context-aware data aggregation module 206 may be, for example, a Korrel8r™ from Red Hat®. Korrel8r™ is a correlation engine for observability signals and observable resources that can correlate multiple domains, diverse signals, inconsistent labeling and varied data stores. The context-aware data aggregation process gathers all of the computing environment's current state information to show relations and trends in a graph automatically.

At step 305, a context-aware data filtering process is used on the context-aware data aggregation results, sent by the context-aware data aggregation module 206, to refine the results and eliminate duplications. The context-aware data filtering process is executed with, for example, a context-aware data filtering module 208 (e.g., a component of observability-based configuration remediation system 110). In some embodiments, the context-aware data filtering process may be rule-based. In some embodiments, the context-aware data filtering module 208 is used to discover information, hidden patterns, and unknown correlations among the data output by the context-aware data aggregation. The context-aware data filtering module 208 is focused on the state of the computing environment at the time of the incident. The context-aware data filtering module 208 produces refined data results including, for example, refined logs, metrics, traces and configurations for the computing environment. Since the static state information about the computing environment's current state is input as well as dynamic state information, refined data results advantageously provide full context about the configuration of the computing environment and the state of the computing environment at a given time window spanning before and after the detection of the incident.

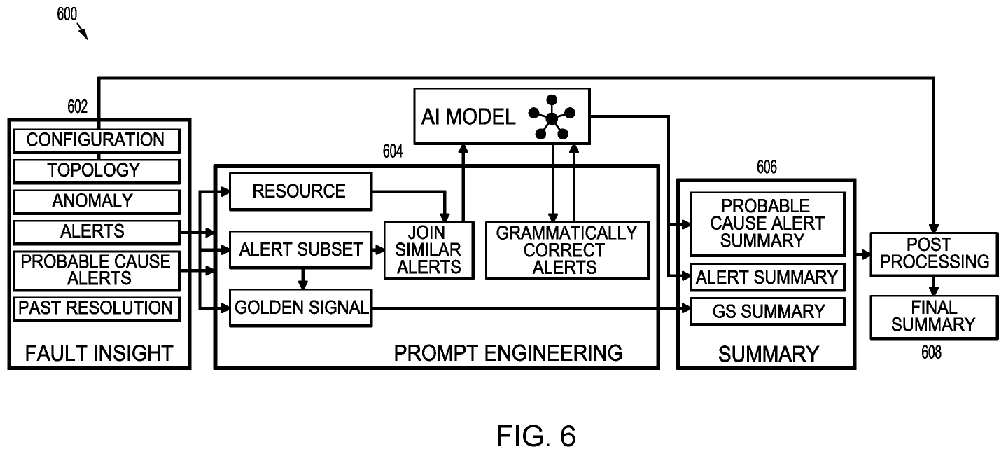

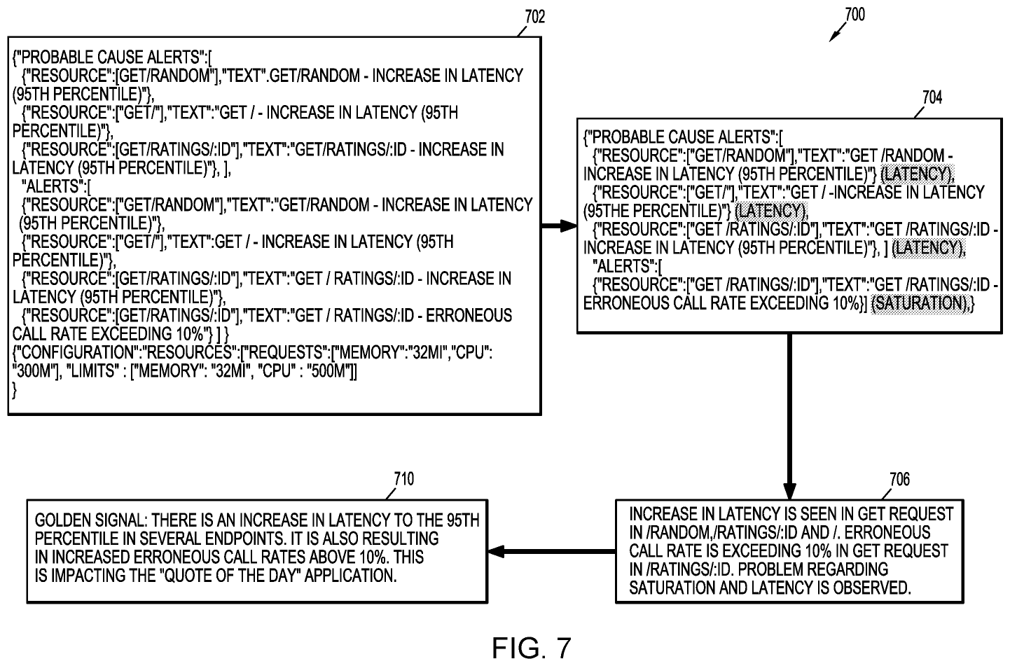

At step 306, the context-aware data aggregation results are input into a prompt engineering system 210 (e.g., a component of observability-based configuration remediation system 110) along with the static state information to create a prompt. Prompt engineering is used to ensure that a prompt is properly structured in order to achieve the advantageous results desired. A properly structured prompt, in accordance with illustrative embodiments of the present disclosure, is one that includes both the dynamic state information and the static state information for the computing environment and for the incident. The prompt should be phrased in a way that is detailed enough to allow a CGC LLM to resolve the issue with a reconfiguration. However, the prompt also should not be overly long or disorganized. Avoiding overly long and disorganized prompts helps the CGC LLM to perform more effective processing. In some embodiments, the prompt engineering system 210 may be performed with artificial intelligence or machine learning assistance by using, for example, an automated or artificially intelligent prompt engineering platform. More details regarding the prompt engineering system 210 will be discussed further below with regard to FIGS. 6 and 7.

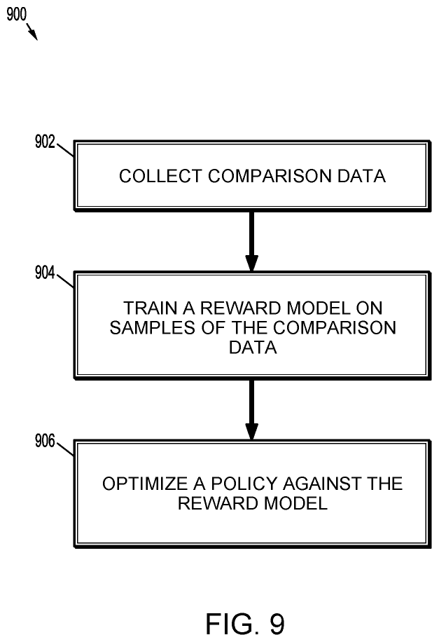

At step 307, the prompt, structured as a textual query, is input into an LLM 212 (e.g., a component of observability-based configuration remediation system 110) with question answering capabilities to generate and output an answer with one or more configuration remediation recommendations. Question answering (QA) LLMs generate human-like, novel responses to user queries. Code generating (CG) LLMs generate computer code using neural network techniques and a large number of parameters to understand and generate code. In some embodiments, the LLM 212 used is a CGC LLM that is trained for multiple tasks, which may combine the functionalities of a QA LLM with a CG LLM. In some alternative embodiments, multiple machine learning models may be used to perform question answering and configuration generation tasks. For example, the LLM 212 may alternatively include a separate QA LLM and CG LLM to perform question answering and configuration generation tasks. In some embodiments, the configuration files (especially for the platform resources such as the pods used in a Kubernetes® environment) for the computing environment 100 are generated using a CG LLM. After the computing environment 100 has been running for some time, incidents may occur. In some embodiments, a separate QA LLM may be used to provide remediation suggestions for the incident based on dynamic state information and static state information provided in a prompt. Then, based on the remediation suggestion, one or more configuration files may be changed (either manually by a user or automatically by the CG LLM) and the original and remediated configuration files are fed back into the CG LLM to improve its configuration generation performance. Improvement by this process will be described in more detail in connection to FIG. 9.

In some embodiments, the LLM 212 is trained on historical data describing prior computing environment incidents and their resolutions, which may specifically be historical events within the computing environment in question or may alternatively be computing environment incidents and their resolutions which happened in other computing environments.

In some embodiments, the answers output at step 307 by LLM 212 include one or more configuration remediation recommendations. In some embodiments, the answer may include one or more configuration remediation recommendations phrased in natural language and/or code sent to a user for user selection (e.g., block 214-1). In some embodiments, a user may be a developer, an administrator, an SRE, or any other user with access to the computing environment and observability information. In some embodiments, the answer may include an automatic reconfiguration of the computing environment to be executed without user intervention needed (e.g., block 214-2). In some embodiments, the answer may also be used to feed back into the CGC LLM in order to train and/or retrain the CGC LLM with human supervision and reinforcement learning (e.g., block 214-3). More details regarding training and retraining the CGC LLM will be described below with respect to FIG. 9.

While CGC LLMs have been used to create computing environment configurations, these CGC LLM have conventionally only been given dynamic state information to analyze. A lack of static state information means that the prompt given to the CGC LLM may not be sufficient to accurately identify the issue and recommend a reconfiguration to resolve the issue without additional information, further processing, and a greater time/resource expenditure. For example, a prompt without static state information of the computing environment, such as the computing environment's configuration during the incident, may lead a CGC LLM to pause the answering process in order to gather more information about the context of the computing environment since dynamic state information alone leave ambiguities. Even when fed the same prompt question, a CGC LLM without static state information will answer the question differently than a CGC LLM with static state information provided. See the following example contrasting the responses of a CGC LLM with and without static configuration information.

For this example, the question provided to the CGC LLM is “I have 5 pods running in my Kubernetes® cluster, and I hit an out of memory error event with one of the pods. How do I resolve this problem?” For a CGC LLM that is not provided static configuration information with the question, the answer will pose further questions. The CGC LLM may answer with “Firstly, let's gather some more information about your setup: (1) Can you tell me the version of Kubernetes® you are using? (2) What type of workload is causing the out of memory error event status in your pods? (3) Have you checked the Pod's resource requests and limits to ensure they match the available resources on your cluster?” These questions essentially create extra steps as they cause a user to collect the information to answer the CGC LLM before a useable answer is provided.

However, for a CGC LLM that is provided static configuration information with the question, the answer will not necessarily require further questions. The CGC LLM may have a more effective answer such as “From what you've shared, it seems like you have an out-of-memory error event occurring in one or your pods with a resource request limit of 1 Mi (mebibyte) per pod. This can happen when the pod requires more memory than what is allocated to it, and the Kubernetes® scheduler cannot provide enough resources to meet its demands. To resolve this issue, you can increase the resource request limits. You can try increasing the resource request limits for the affected pod(s) by using the ‘resourceRequests’.”

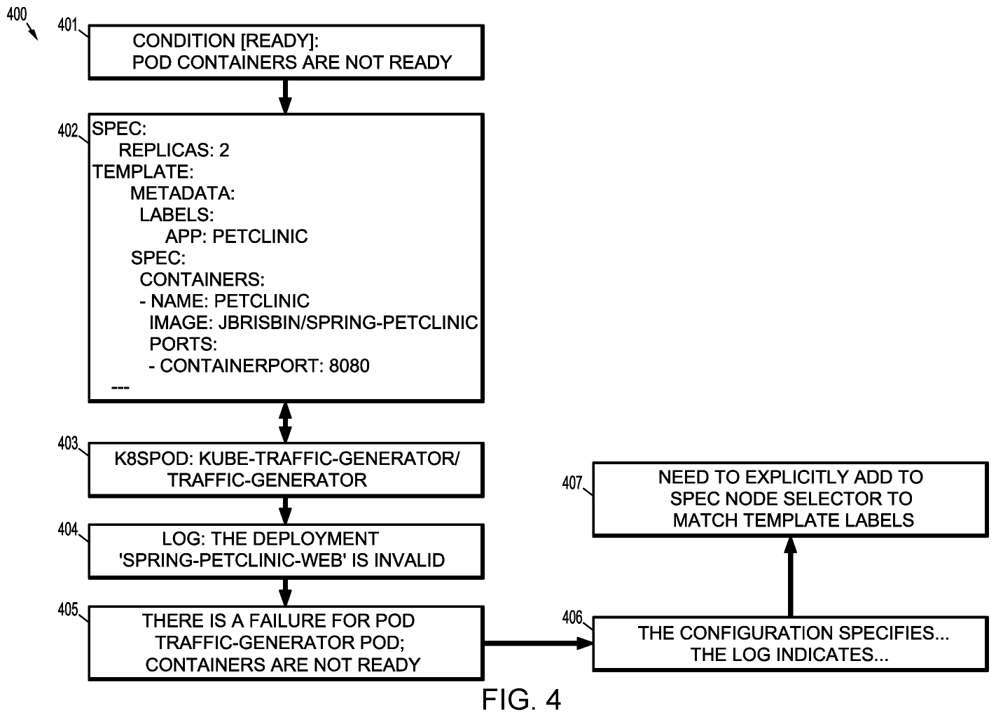

In some embodiments, methodology 300 of FIG. 3 can be applied to manage an exemplary Kubernetes® computing environment in the event of an incident, as in an example application 400 of FIG. 4. Referring now to FIG. 4, the example application 400 of an observability-based configuration remediation process (e.g., operational flow 200 and methodology 300) is depicted in connection with an example Kubernetes® computing environment. The configuration specification language used in connection to FIG. 4, YAML, is typically used for defining configurations for Kubernetes® computing. YAML is a human-readable data serialization language that is often used for writing configuration files. YAML is used for data rather than documents and is a commonly used programming language because it is designed to be easily read and understood. YAML may also be used in conjunction with other programming languages, allowing flexible use.

At step 401, the event detected is that the pod containers are not ready within the computing environment. At step 402, the observability tool has collected logs, metrics, traces, and configurations for the computing environment. At step 403, the fault localization process and root cause failure analysis have developed the list of suspect entities and the related objects for the computing environment. In the depicted embodiment of step 403, a single entity has been identified as related to the incident in question, which in this instance is the K8s Pod: kube-traffic-generator/traffic-generator within the computing environment. The other entities that are running in the system have not been included because the fault localization process has determined that they have no connection to the incident and therefore will not be provided to the following steps. In some embodiments, a fault localization process may precede step 402 so that the only logs, metrics, traces and configurations for the computing environment that are collected are already identified as being connected to the incident (not included in FIG. 4). At step 404, the dynamic and static state information regarding the computing environment is input to a context-aware data aggregator, resulting in a determination through a log that the deployment ‘spring-petclinic-web’ is invalid. At step 405, the context-aware data aggregation result for the dynamic and static state information is then input to a context-aware data filter, which determines that there is a failure for pod traffic-generator and that the containers in this pod are not ready. At step 406, the result of the context-aware data filter is input to a prompt engineering system along with the static state information for the computing environment. At step 407, the prompt engineering system generates and inputs a prompt into a CGC LLM, which causes the CGC LLM to produce the resolution recommendation that the user needs to explicitly add to spec node selector to match the template labels in order to reconfigure the system.

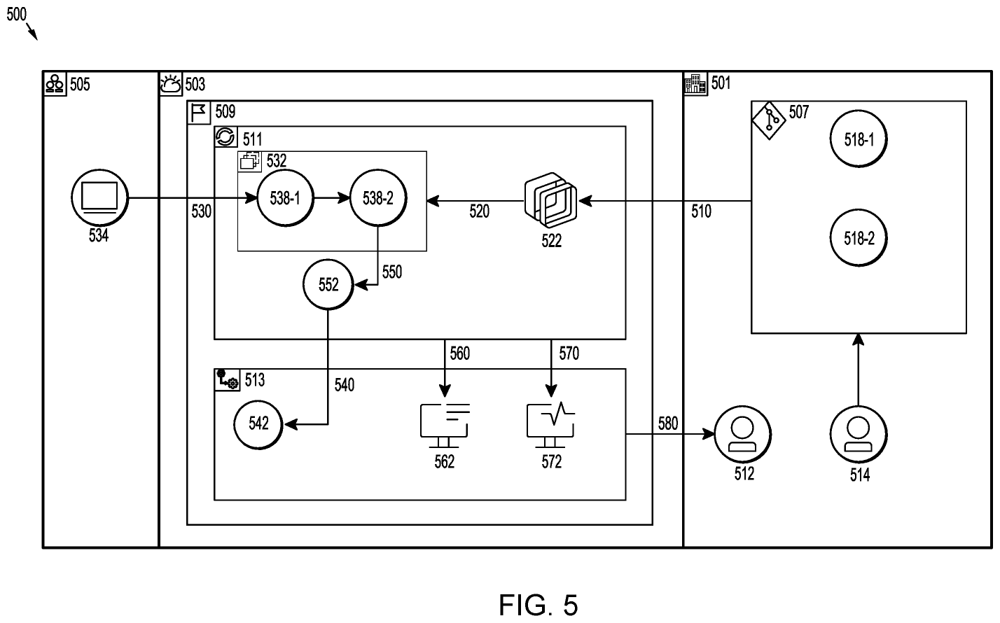

In some embodiments, the operational flow 200 of FIG. 2 and the methodology 300 of FIG. 3 may be applied to a variety of computing environments and systems such as an example computing environment 500 of FIG. 5. Referring now to FIG. 5, the example computing environment 500 is depicted to illustrate how observability tools, such as are part of observability-based configuration remediation system 110, have observability capabilities throughout a computing environment so that observability-based configuration remediation (e.g., operational flow 200 and methodology 300) may be performed. Development environment (DEV) 501 is depicted with an administrator 512, a developer 514, and a global information tracker (GIT) 507. The GIT 507 contains a first worker node 518-1 and a second worker node 518-2. In some embodiments, the first worker node 518-1 includes a frontend user interface. In some embodiments, the second worker node 518-2 includes a backend database. In step 510, the DEV 501 containerizes and deploys enterprise workloads in clusters and sends them to a cloud environment 503. In some embodiments, step 510 is accomplished by creating a Red Hat® OpenShift® cluster on an IBM Cloud® cluster. Red Hat® OpenShift® clusters build on Kubernetes® container orchestration. In some embodiments, cloud environment 503 may be an IBM Cloud® cluster.

Cloud environment 503 includes a region 509 which further contains a cluster 511 and cloud services 513. In some embodiments, cluster 511 is a Red Hat® OpenShift® cluster. In some embodiments, cloud services 513 are IBM Cloud® services. Cluster 511 includes a builder 522, a container registry 532 and a cloud operator 552. The container registry includes a frontend user interface node 538-1 and a backend database node 538-2. Cloud services 513 includes a cloud database 542, a log analysis platform 562, and a cloud monitoring platform 572. In some embodiments, the cloud database 542 includes an IBM® Cloudant® database. A builder is a design pattern that separates the construction of a complex object from its representation. The builder 522 allows the construction of complex objects by extracting the object construction code out of the complex object's class and moving it. The builder 522 does not allow other objects to access the product while it's being built. Unlike other creational patterns, the builder 522 does not require products to have a common interface, making it possible to produce different products using the same construction process.

In step 520, the builder 522 clones the source information from the first worker node 518-1 and the second worker node 518-2 from the DEV 501 to create an image. The image is then pushed to the container registry 532 to be used in a deployment configuration provisioning process with the frontend user interface node 538-1 and the backend database node 538-2.

In step 530, a user 534 in a public network 505 may then access the frontend user interface node 538-1. The user 534 can access logs, applications, and observability tools to monitor and interact with the cloud environment 503.

In step 540, the cloud database 542 is provisioned through the cloud operator 552 to allow the user to explore the monitoring and metrics dashboards included in the frontend user interface node 538-1. In some embodiments, the dashboards are predefined. In some embodiments, the metric dashboard allows a user to run queries and examine the metrics in a visualized plot to provide an overview of the cluster 511 state and to manage issues.

In step 550, the backend database node 538-2 is connected to the cloud database 542 via the cloud operator 552. The metrics that are able to be observed by step 540 can then be used to scale the user interface application in response to the workload received. To allow such scaling to be done automatically, maximum central processing unit (CPU) and memory resource limits must be established.

In steps 560 and 570, the cloud services 513 and the cluster 511 are further connected by provisioning log analysis platform 562 and provisioning cloud monitoring platform 572 to allow log analysis and monitoring of applications run by the user through the frontend user interface node 538-1.

In step 580, the administrator 512 is able to monitor the applications within the cloud environment 503 through the log analysis platform 562 and the cloud monitoring platform 572 as cloud services 513 is connected to DEV 501. Therefore, the example computing environment 500 is fully observable by the developer 514, the administrator 512 and the user 534 so that the observability information may be used to troubleshoot and reconfigure the example computing environment 500 when issues and failures occur. The references to the developer 514, the administrator 512 and the user 534 refer to a human using a computer/computing node as indicated in the computing environment 500.

In some embodiments, the prompt engineering (as depicted in steps as described above and in FIGS. 2, 3 and 4) may be executed with artificial intelligence assistance, as depicted in one illustrative embodiment with an operational flow 600 of FIG. 6. Referring now to FIG. 6, the operational flow 600 for the process of summarizing the dynamic state information relating to the incident detected and incorporating the static state information to create a prompt to input into a CGC LLM is illustrated. At step 602, a computing environment current state information set is collected (e.g., following context-aware data filtering as executed in steps 305 and 405) and portions of the computing environment current state information set are then sent to a prompt engineering system. The computing environment current state information set includes a static state information set including the configuration and the topology of the computing environment. The computing environment current state information set further includes a dynamic state information set including the type of anomaly occurring (e.g., incident type), alerts associated with the anomaly, probable cause alerts associated with the anomaly, past resolution information, and fault insight from the fault localization and root cause failure analysis performed (e.g., in steps 303 and 403). The static state information set is sent to a post processing step 608, while the dynamic state information set is sent through additional processing to reach the prompt engineering system.

At step 604, the dynamic state information set is sorted into a resource information subset, an alert information subset, and a golden signal (GS) information subset (including latency, traffic, errors, and/or saturation information). Golden signals are four signals that aid in the consistency and accuracy of monitoring and tracking service health across applications and infrastructure within a computing environment. The four golden signals are latency, traffic, errors, and saturation. The GS information can provide further context to the health of the computing environment to aid with the prompt engineering process. The resource information subset and the alert information subset are sorted to join similar alerts and eliminate redundancies. The resulting information is sent to an artificial intelligence (AI) model which is used to grammatically correct the alerts and create a final reduced information set. The AI model is a generative AI model that is trained to produce a prompt that includes natural language to describe a task/issue that a machine learning model should perform/resolve. This AI model is trained in some embodiments using similar datasets and supervised training with desired output of the model being a label that is a prompt that is matched with a certain set of the above-described resource information.

At step 606, that information set is then fed back into the AI model to produce an alert summary and a probable cause alert summary. The GS information subset is also summarized by the prompt engineering system to produce a GS summary.

At step 608, the GS summary, the alert summary and the probable cause alert summary are combined with the static state information set in a post processing service. The post processing service combines the static state information set with the summaries to outline the problem and the incident information. Then, the outlined problem and incident information is then reworked into a final, coherent prompt to be fed into the CGC LLM.

Referring now to FIG. 7, exemplary pseudocode 700 illustrates an exemplary application of the operational flow 600 of FIG. 6 when applied to information collected by an observability tool (e.g., part of observability-based configuration remediation system 110). The exemplary pseudocode 700 is further depicted in YAML language with a final answer output in a natural language format. Portion 702 illustrates the computing environment current state information set that is collected. Portion 704 illustrates the information after being sorted to join similar alerts, processed to eliminate redundancies and then grammatically corrected by the AI model. Portion 706 illustrates the GS summary, the alert summary and the probable cause alert summary after being combined with the static state information set. Portion 708 illustrates the final, coherent prompt to be fed into the CGC LLM, referencing the GS information, dynamic state information, and static state information in a natural language answer.

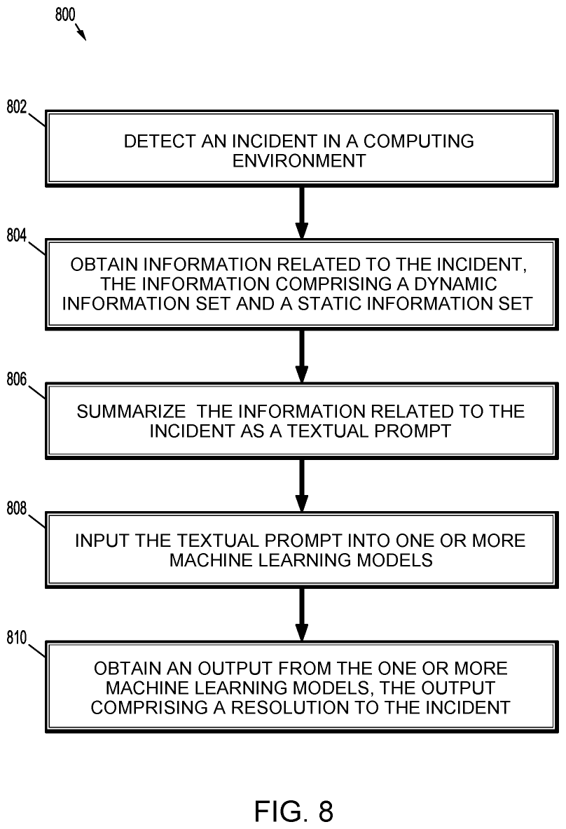

Referring now to FIG. 8, a methodology 800 is depicted for observability-based configuration remediation as may be applied to computing environment 100 and/or example computing environment 500. At step 802, an observability tool detects an incident in an operational cloud environment. At step 804, information related to the incident is obtained. The information includes a dynamic state information set and a static state information set. At step 806, information related to the incident is summarized as a textual prompt. At step 808, the textual prompt is input into one or more machine learning models such that the one or more machine learning models, in response, generate an output comprising a resolution to the incident.

Referring now to FIG. 9, a methodology 900 is depicted for improving a CGC LLM, or a set of LLMs including a QA LLM and a CG LLM, based on remediated configurations, as may be applied to illustrative embodiments of the operational flow 200 and in methodologies 300 and 800. As mentioned above, the claimed CGC LLM is trained on historical data describing prior computing environment incidents and their resolutions, which may specifically be historical events within the computing environment in question or be computing environment incidents and their resolutions which happened in other computing environments. When a computing environment (e.g. Kubernetes®) is running, all entities within the computing environment (e.g. infrastructure components, platform applications, running applications, etc.) have configuration files associated with them. In some embodiments, the configuration files are generated using a CG LLM (which may be a separate LLM or a trained portion of a single CGC LLM). After the computing environment has run for some time, incidents may occur indicating a functional failure or a performance failure. In some embodiments, when an incident occurs, a QA LLM (which may be a separate LLM or a trained portion of a single CGC LLM) is used to provide remediation suggestions for the incident based on the dynamic state information and the static state information input as an engineered prompt. Based on the remediation suggestion, one or more configuration files are changed, either manually by a user or automatically by the CG LLM and/or CGC LLM to remediate the incident. Following the remediation of the incident, the CG LLM and/or CGC LLM may be improved. Additionally, as the CGC LLM continues to resolve configurations for a specific system, a feedback system may use the answers output by the QA LLM and/or the CGC LLM to train and retrain with new resolutions and contextual data to improve over time in accordance with the methodology 900.

At step 902, comparison data is collected. Comparison data consists of triplet information set, and each triplet information set includes the prompt that was fed to the CGC LLM (either to a separate QA LLM or to a portion of a singular CGC LLM trained for question-answering), the original configuration of the computing environment, and the resulting remediated configuration that was used to resolve an incident that occurred. The prompt was used as an input to the CGC LLM to create the original configuration. The remediated configuration was obtained only after the incident occurred, based on the recommended remediation suggested or enacted as an output of the CGC LLM.

At step 904, a reward model is trained on samples of the comparison data. Triplet information sets are sampled from the comparison data, and the original configurations are ranked according to their distance from their remediated configurations, e.g., using Jaccard similarity or other distance metric. The smaller the distance is to the remediated configuration, the higher the original configuration is ranked. This sampled data is used to train a reward model.

At step 906, a policy is optimized against the reward model. A Proximal Policy Optimization Reinforcement Learning (PPO RL) algorithm is used to adjust the CGC LLM's (either a separate CG LLM or to a portion of a singular CGC LLM trained for code generation and configuration generation) parameters so that the produced outputs are more likely to receive high reward. This is in accordance with standard LLM performance improvement using PPO RL.

Advantageously, illustrative embodiments may use unstructured free text and unlabeled configuration information to describe incidents in a computing environment. Illustrative embodiments further advantageously use a general purpose LLM to recommend and, in some embodiments, automatically apply a resolution to the incident. Illustrative embodiments enable a general solution to, without any prior study, examination or assumptions, identify a type of incident that is occurring in a computing environment, the type of devices involved in the incident, and the resolution to the incident. Illustrative embodiments are advantageous in that there is no need for human labeling to identify the type of incident, the type of devices involved in the incident, and the resolution to the incident. As such, the applicability of a general LLM for use in observability-based configuration remediation is significantly increased by incorporating static configuration information into the process of describing an incident to the LLM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

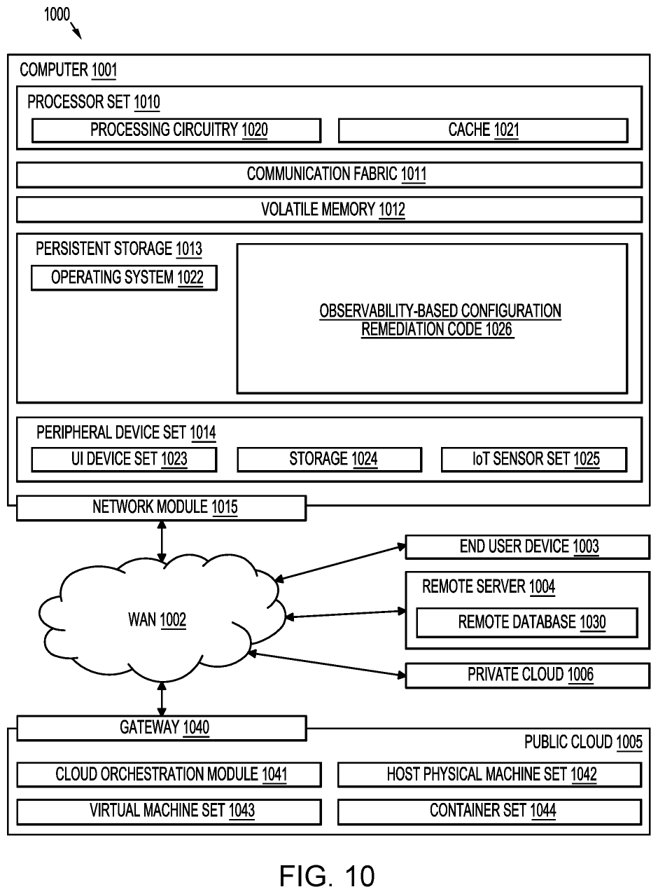

Referring now to FIG. 10, a computing environment 1000 contains an example of an environment for the execution of at least some of the computer code involved in performing the inventive methods, adaptive observability-based configuration remediation code 1026 (also referred to as “block 1026”). In addition to block 1026, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1026, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

Computer 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

Processor set 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer-readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1026 in persistent storage 1013.

Communication fabric 1011 is the signal conduction path that allows the various components of computer 1001 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

Persistent storage 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in block 1026 typically includes at least some of the computer code involved in performing the inventive methods.

Peripheral device set 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

Network module 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer-readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

Remote server 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

Public cloud 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

Cloud computing services and/or microservices (not separately shown in FIG. 10): private and public clouds 1005 and 1006 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from frontend clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application program interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
detecting an incident in a computing environment;
obtaining information related to the incident, the information comprising a dynamic state information set and a static state information set;
summarizing the information related to the incident as a textual prompt; and
inputting the textual prompt into one or more machine learning models such that the one or more machine learning models, in response, generates an output comprising a resolution to the incident;
wherein the computer-implemented method is performed by a processing platform executing program code, the processing platform comprising one or more processing devices, each of the one or more processing devices comprising a processor coupled to a memory.

2. The computer-implemented method of claim 1 further comprising applying a root cause failure analysis process on the obtained information such that a reduced set of information is generated that relates to a subset of entities within the computing environment.

3. The computer-implemented method of claim 1, wherein at least one machine learning model of the one or more machine learning models is a large language model (LLM).

4. The computer-implemented method of claim 3, wherein the LLM is one or more of a question answering LLM and a configuration generation LLM.

5. The computer-implemented method of claim 3, wherein the LLM is trained on historical data, the historical data comprising prior incidents in the computing environment and prior resolutions to the prior incidents in the computing environment.

6. The computer-implemented method of claim 1, wherein the dynamic state information set comprises one or more of events, traces, logs, and metrics of a given time window before and after the detection of the incident.

7. The computer-implemented method of claim 1, wherein the static state information set comprises one or more of a state of one or more applications in the computing environment, a state of one or more infrastructure components of the computing environment, a configuration of the computing environment, a configuration of one or more entities in the computing environment and one or more resource types of the computing environment.

8. The computer-implemented method of claim 1, wherein the incident indicates a potential functional failure of the computing environment.

9. The computer-implemented method of claim 1, wherein the incident indicates a potential performance failure of the computing environment.

10. The computer-implemented method of claim 1, wherein the resolution to the incident comprises recommended changes to a configuration of the computing environment.

11. The computer-implemented method of claim 1, wherein the output from the one or more machine learning models is input into at least one machine learning model of the one or more machine learning models to retrain the at least one machine learning model with the resolution to the incident, wherein the resolution to the incident comprises at least one remediated configuration.

12. A computer system comprising:
a processor set;
a set of one or more computer-readable storage media; and
program instructions, collectively stored in the set of one or more storage media, for causing the processor set to perform computer operations comprising:
detecting an incident in a computing environment;
obtaining information related to the incident, the information comprising a dynamic state information set and a static state information set;
summarizing the information related to the incident as a textual prompt; and
inputting the textual prompt into one or more machine learning models such that the one or more machine learning models, in response, generates an output comprising a resolution to the incident.

13. The computer system of claim 12, wherein the computer operations further comprise applying a root cause failure analysis on the obtained information such that reduced information is generated that relates to a subset of entities within the computing environment.

14. The computer system of claim 12, wherein the dynamic state information set comprises one or more of events, traces, logs, and metrics of a given time window before and after the detection of the incident.

15. The computer system of claim 12, wherein the static state information set comprises one or more of a state of one or more applications in the computing environment, a state of one or more infrastructure components of the computing environment, a configuration of the computing environment, a configuration of one or more entities in the computing environment and one or more resource types of the computing environment.

16. The computer system of claim 12, wherein the incident indicates at least one of a potential functional failure of the computing environment and a potential performance failure of the computing environment.

17. A computer program product comprising a computer readable storage medium having program instructions embodied therewith, the program instructions executable by one or more processors to cause the one or more processors to perform computer operations comprising:
detecting an incident in a computing environment;
obtaining information related to the incident, the information comprising a dynamic state information set and a static state information set;
summarizing the information related to the incident as a textual prompt; and
inputting the textual prompt into one or more machine learning models such that the one or more machine learning models, in response, generates an output comprising a resolution to the incident.

18. The computer program product of claim 17, wherein the computer operations further comprise applying a root cause failure analysis on the information such that a reduced set of information is generated that relates to a subset of entities within the computing environment.

19. The computer program product of claim 17, wherein the dynamic state information set comprises one or more of events, traces, logs, and metrics of a given time window before and after the detection of the incident.

20. The computer program product of claim 17, wherein the static state information set comprises one or more of a state of one or more applications in the computing environment, a state of one or more infrastructure components of the computing environment, a configuration of the computing environment, a configuration of one or more entities in the computing environment and one or more resource types of the computing environment.
